(19) United States
(12) Patent Application Publication
(10) Pub. No.: US 2015/0198546 A1
(43) Pub. Date: Jul. 16, 2015

(54) STEAM QUALITY METER

(71) Applicant: CONOCOPHILLIPS COMPANY, Houston, TX (US)

(72) Inventors: Jianshe WANG, Calgary (CA); James SEABA, Calgary (CA)

(21) Appl. No.: 14/591,149

(22) Filed: Jan. 7, 2015

Related U.S. Application Data
(60) Provisional application No. 61/927,151, filed on Jan. 14, 2014.

(51) Int. Cl. G01N 25/60

(52) U.S. Cl. CPC G01N 25/60

(57) ABSTRACT

A real time and online apparatus and methods measuring steam quality of a moving steam sample stream by superheating or cooling to subsaturated water using a known amount of heat and mass. The meter allows for continuous flow and can be used for verification and calibration of other steam quality measurement device.

### CROSS REFERENCE TO RELATED APPLICATIONS

This application claims benefit of U.S. Patent Application Ser. No. 61/927,151 filed Jan. 14, 2014, entitled “STEAM QUALITY METER,” which is hereby incorporated by reference.

### FEDERALLY SPONSORED RESEARCH STATEMENT

Not applicable.

### REFERENCE TO MICROFICHE APPENDIX

Not applicable.

### FIELD OF THE DISCLOSURE

Embodiments of the invention relate to methods and apparatuses for measuring steam quality, which may be online steam quality determinations at steam injection wellheads or at locations remote from a steam generator.

### BACKGROUND OF THE DISCLOSURE

Effective production of hydrocarbon reservoirs containing heavy oils presents significant challenges. Extraction of these high viscosity hydrocarbons is difficult due to their relative immobility at reservoir temperature and pressure. Some hydrocarbons may be quite thick and have a consistency similar to that of peanut butter or heavy tars, making their extraction from reservoirs difficult.

Conventional approaches for recovering heavy oils, such as bitumen, often focus on lowering the viscosity through the addition of heat. Commonly used in situ extraction thermal recovery techniques include a number of reservoir heating methods, such as steam flooding, cyclic steam stimulation, and Steam Assisted Gravity Drainage (SAGD). SAGD is the most extensively used technique for in situ recovery of bitumen resources in the McMurray Formation in the Alberta oil sands and other reservoirs containing viscous hydrocarbons.

In a typical SAGD, two horizontal wells are vertically spaced by 4 to 10 meters (m). The production well is located near the bottom of the pay and the steam injection well is located directly above and parallel to the production well. In SAGD, steam is injected continuously into the injection well, where it rises in the reservoir and forms a steam chamber. The heat from the steam reduces the oil's viscosity, thus enabling it to flow down to the production well and be transported to the surface via pumps or lift gas.

As its name implies, generation of high quality, high temperature and high-pressure saturated steam is a prerequisite for the SAGD and other steam injection processes. Depending on the reservoir condition, specifications for the steam used for SAGD and other steam injection processes varies from 2,500-11,000 kPa and about 230° C.-320° C., ideally with a high steam quality up to 100%. Steam capacity is determined by the steam-to-oil (SOR) ratio, which normally ranges around 2-4. Considering oil production volume (10,000 to 100,000 BPD depending on the well size), water requirement for steam generation is immense.

In principle, the effectiveness of the steam injection is based on the amount of heat energy being injected into the reservoir. Due to heat loss and other factors, steam quality degrades along the path from steam generator to the subsurface oil reservoir. Furthermore, steam quality may decrease because of an uneven distribution into wells through the pipeline network due to its two phase nature. As such, measuring steam quality at the point of steam generation is of very limited value. To calculate the heat energy of the saturated steam, and thus its effectiveness, one must know steam quality at the wellhead or another location remote to the steam generator.

The ability to continually measure steam quality for each well is one of the key parameters to predict oil recovery and to optimize the reservoir performance. Though steam quality can be measured at the outlet of the steam generator, the industry has no acceptable way to measure steam quality at the wellhead or at positions remote from the steam generator. Currently, no calibration or verification method or meter considered to be satisfactory for steam quality measurement exist at the wellhead or anywhere within a pipeline. Thus, the industry relies on mathematical calculations to estimate the steam quality without a way to verify actual steam quality at the wellhead or at remote locations.

Measuring actual steam quality in oil recovery operations is acknowledged to be a challenging technical problem due to the special nature of saturated steam, as well as due to the special circumstances of remote location use. Specifically:

1. As a condensable gas, phase change directly affects steam quality. System energy and heat changes usually result in a phase change. Heat loss through the pipe walls to the environment surrounding the pipes result in some steam condensing into water, thus reducing steam quality.

2. Measuring latent heat associated with steam quality is very difficult since it cannot be measured by the temperature and/or pressure of the saturated steam.

3. The very fast flow rate in the pipeline combined with the high temperature and high pressure requirements of the steam further complicates the measurement process.

4. There is a general lack of a reliable way of measuring mass flow rate due to two phase flow and unknown density of the steam.

Therefore, a need exists for methods and apparatus that measure steam quality with reliable results in operational conditions.

### SUMMARY OF THE DISCLOSURE

The present disclosure describes a novel steam quality meter that allows for continuous flow of steam whose quality is measured periodically or semi-continuously and a method of using such meter. Using a total mass measurement unit and mass removing system as well as accounting for inconstant temperature and pressures, the present meter offers a reliable and accurate determination of steam quality.

In one embodiment, the meter includes one or more of the following:

a steam sampling unit having a spool and tip for obtaining a continuous flowing steam stream from a steam pipe;

an insulated adiabatic hot box unit having a series of electrical coils and metal tubes or metal grids with open ends for quickly heating the steam;

a cold box having a series of coils or other type of heat exchanger and a cooling means for condensing the superheated steam;

a total mass measurement and removing unit consisting of an open top cup, electric mass balance, liquid withdraw sucking pump, and line and valves connects to them.

a series of temperature and pressure sensors located at the inlets, outlets and other locations of the above units;

a series of valves located at the inlets and outlets of the hot and cold box for enclosing the steam sample within the adiabatic hot and cold box to allow for effective controlling of the flow stream;

a set of electric energy units for providing and monitoring electric current, voltage, frequency and time information to be consumed by the hot box;

a programmable process controller for controlling the process and collecting measured parameters from the electrical energy measurement units, mass and removal units, and other sensors, wherein the parameters include back pressure, measurement time period, heating, cooling, mass, condensate removing. The processer uses this information to perform the calculation, display the results and provide output to its client. Additionally, the controller controls the sampling, heating, cooling, and valves within the meter.

In another embodiment, the meter has the above elements but further comprises an alert system. Thus, in addition to displaying process information, the processer can also alert, text, or email the operator if the steam quality falls below a predetermined level.

This disclosure provides a steam quality meter process and apparatus based on known thermodynamic principles wherein the meter includes a sampling unit located inside a steam pipeline, a hot box unit equipped with an induction heater, a cold box unit with a steam condensing cooler, a mass measurement removing unit and a process controller that controls the various units in the meter and performs calculations, as shown in FIG. 1A. While shown here with a steam pipeline sample, the present meter can also be used at the injection well head or steam generator.

The meter is designed to be capable of measuring steam quality based on the total mass of a sample and the corresponding heat added by the hot box instead of mass flow rate. The meter allows for continuous flow of steam to provide a dynamically stabilized flowing condition. Because the flow is never halted, the sample is measured by either a predetermined collection time of the condensed steam (e.g. 20 minutes of collection before being removed) or a predetermined mass measurement (e.g. collect 500 g of condensed steam before being removed). Upon the end of the measurement period, the collected sample is removed from the meter and the processor calculates the steam quality for the sample.

The steam quality measurement period starts when the dynamic stable condition is established. A dynamic stabilized condition is established through adjusting the impacting parameters including: steam sample stream flow rate, inputting heat rate, system back pressure, temperature of the metal tubes/grids, and the cooling rate. The system is considered dynamically stable when the temperature and pressure gradient between the outlet and inlet of the hot box is stabilized. Stabilized condition is also evidenced when the inputting energy into the hot box is stabilized. Together, the use of the total mass and the dynamically stabilized flow offer an improvement in measurement accuracy and reliability over the prior art.

In more detail, this novel steam quality measurement method and apparatus adopts a process of inconstant pressure and temperature across the apparatus to measure steam that is continuously flowing through the unit during a measurement period. This process is made possible by incorporating an inductive heating system and mass measuring system with a removal unit to facilitate measurement of the entire sample mass. Such an apparatus provides the most direct and theoretically countable steam quality measurement method and equipment.

The mass measuring system and removal unit allows for a “sampling” to be taken from a continuously flowing steam stream. Specifically, the meter's measurement period is based on either a specific mass of condensed steam or a specific collection time. For example, the steam quality can be measured for a total mass of e.g. 500 grams of condensed steam collected or for a unit of time of e.g. 20 minutes of collection. Thus, any desired mass or unit of time measurement period can be adopted. Note, the steam quality and its measurement is not affected by the chosen measurement period because steam quality is an intrinsic physical property.

For mass-based measurement periods, 200-1000 grams of condensed steam may be collected per measurement period, preferable 400-800 grams and most preferably 500 grams. For time-based measurement periods, a collection period of 10-60 minutes can be used, preferably about 20 minutes. The meter itself can be utilized as a calibration or verification tool due to the fact that it measures the energy required to alter steam quality and directly measures the total mass corresponding to this steam quality change. In other words, the meter provides a direct measurement of the property in question.

The steam quality calculation accounts for inconstant pressure and temperature settings of a continuous flowing steam stream leaving the hot box. The meter adds heat to the steam until it is stabilized to a certain degree in the ‘superheated’ region and then calculates quality based on thermodynamic principles of energy balance and conservation. Because the steam is continuously flowing, the pressure and temperature gradient is established between the steam entering and exiting the hot box. Through processer control unit, this temperature and pressure gradient is adjusted to a dynamic stabilized condition before the meter system is ready to take a measurement. In other words, measurement periods only start when the temperature and pressure gradient is stabilized.

An induction heating unit with large surface metal conduits allows for a fast and effective heat transfer to the steam sample, due to electric and heat energy conversion through an induction magnetic field.

The mass measurement and removing method utilized by the apparatus allows for total mass measurement not based on flow rate. This allows for a continuous flow of steam even when steam quality measurements are taken periodically or semi-continuously.

Typically, analysis of a steam sample occurs in a traditional analytical laboratory located away from the wellpad with samples taken close to the steam generation point. The present meter allows for steam quality analysis in locations that are remote to and not accessible by a traditional laboratory. The meter disclosed herein is portable and can be installed on the steam flow line at any point between steam generation and well injection. In an oil recovery or geothermal application, the meter is envisioned to be used to collect samples at the steam injection well head and/or steam pipeline.

The meter further matches the physical process with the calculation assumptions; clarifies that metering process has inconstant pressure or temperature; purposely heats steam to the superheated region; and takes measurement readings at dynamic stabilized flowing condition. Heat is added to a continuously flowing steam stream to heat the steam into a superheated state. The superheated enthalpy h_{d} associated with the superheated region is accounted for by the calculations.

Underlying calculations of the present meter allow for a direct application of thermodynamic principles, including energy conservation and heat balance. Specifically, the calculation does not require a constant pressure and temperature process. Only starting and end states are required for calculation.

The presently designed hot box unit is able to effectively deliver electric energy and convert it into heat energy via an induction magnetic field for transferring to the steam sample by using a multi-conduit grid with both ends open to enable heat transfer on the inner and outer surfaces. This design facilitates the heat transfer process and makes the steam quality measurement possible for fast moving saturated steam within a practically manageable measurement period.

Optionally or alternatively, the presently designed steam quality meter can remove heat from the steam sample stream and convert it into sub-saturated water region.

The presently designed mass measurement system is able to measure the total mass directly corresponding to the related energy transferred. The presently designed removal unit allows for condensed steam to be quickly and efficiently removed after and between each periodic measurement. The sampling unit allows for the meter to be installed on an oil well head or online of a steam pipeline and performs the measurement without access to any traditional steam quality measurement laboratory.

As used herein, the term “steam quality” is defined as the ratio of the mass of water vapor to the total mass of water vapor and liquid of a steam sample. Thus, a steam quality of 0% would be pure liquid, while a quality of 100% would be pure vapor. Steam quality X_{B} is also expressed in terms of heat energy by the following question:

$${X}_{b} = \frac{{h}_{b} - {h}_{f}}{{h}_{g} - {h}_{f}}$$

As used herein, the term “semi-continuous” is defined measurements performed in series of periodic measurements that repeat between certain time gaps.

As used herein, the term “steam regions” refers collectively to the different phases found on a temperature/enthalpy diagram for water including water, saturated steam and superheated steam. The steam quality is 100% at the cusp of the saturated steam and superheated steam phases.

As used herein, the term “dynamic stabilized condition” means temperature and pressure gradient between inlet and outlet of hot box is stabilized by inputting a known electric energy at a certain steam stream flow rate.

As used herein, the term “saturated steam”, means wet steam.

The use of the word “a” or “an” when used in conjunction with the term “comprising” in the claims or the specification means one or more than one, unless the context dictates otherwise.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

The following abbreviations are used herein:

| ABBREVIATION | TERM |
|---|---|
| ATM | Atmosphere |
| BFW | Boiler feed-water |
| CAPEX | Capitol expenses |
| CPF | Central processing facility |
| CSS | Cyclic steam stimulation |
| ES-SAGD | Expanding solvent SAGD |
| OPEX | Operating expenses |
| OTSG | Once-through steam generator |
| SAGD | Steam-assisted gravity drainage |
| SD | Steam drive |
| SOR | Steam-to-oil ratio |
| TDS | total dissolved solids |
| Ts | Saturation temperature |
| UF | Ultrafiltration |
| T | Temperature |
| P | Pressure |
| X | Steam quality |

### BRIEF DESCRIPTION OF THE DRAWINGS

FIG. 1A illustrates a simplified schematic of the steam quality meter, wherein the system includes a sampling unit, a superheating unit, also called hot box, a condensing unit also called cold box, a mass measurement and removing unit and a process controller.

FIG. 1B illustrates a detailed schematic of the steam quality meter of FIG. 1A.

FIG. 2A shows a process on enthalpy and pressure diagram and how target h_{b} is determined from h_{d} in superheated region.

FIG. 2B shows an enthalpy and temperature diagram with steam quality point to be measured for explaining quality calculation after h_{b} is known.

FIG. 3 illustrates a schematic of detailed description of the sampling unit.

FIG. 4A illustrates a schematic of hot box according to one embodiment of the present disclosure.

FIG. 4B illustrates a cross-section of the hot box of FIG. 4A.

FIG. 5 illustrates a schematic of the mass measurement and removing unit where continued flow and periodic measurement can be archived.

FIG. 6 illustrates a schematic of a steam quality meter employing heat quenching.

FIG. 7 shows an enthalpy and pressure diagram corresponding to an embodiment of the heat quenching method.

FIG. 8 shows an enthalpy and temperature diagram corresponding to an embodiment of the heat quenching method.

FIG. 9 shows a close-up view of a quenching unit.

FIG. 10 shows a close-up view of a refrigeration unit.

### DETAILED DESCRIPTION

The disclosure provides a novel steam quality measurement apparatus that allows a steam stream to flow continuously, but only takes steam quality measurements periodically. The measurement cycle is repeated to form semi-continuous measurements on the continuously flowing steam stream. Some embodiments provide the process method to measure steam quality at continued flowing condition, an inductive heater to increase temperature of the steam into the superheated region, as well as the computation method.

The apparatus includes a sampling unit for obtaining a continuous stream of fast moving steam from a steam pipeline. A sampling port has a receiver that is shaped to reduce momentum-related pressure and heat loss.

An adiabatic hot box fluidly connects to the sampling unit. The hot box has an inlet and an outlet, each with one or more sensors and a valve, and an inductive heater between said inlet and outlet, with one or more electrical coils surrounding a heater shell that houses open end metal structures placed concentrically around a solid velocity distributor for diverting said fast moving steam into said metal structures, wherein said inductive heater superheats said fast moving steam by forcing contact with said inductively heated metal tubes or grids. The metal structures are magnetic and heat conducting material to allow for a fast and even transfer of heat from the heater to the fast-moving steam.

A condensing cold box fluidly connects to the adiabatic hot box. The cold box has an inlet and an outlet, each with a valve. The outlet also has at least one sensor. The cold box has a cooler for condensing the superheated fast moving steam into a lower-than-boiling point liquid.

A mass measurement and sample removal unit fluidly connects to the cold box. The mass measurement and sample removal unit has a mass cup for collecting the condensed steam, and mass balance for weighing the condensed steam. The mass cup also has a pump for removing the condensate after it is weighed. The removed condensate can be reused in the steam process or may be discarded.

In addition to the temperature and pressure sensors, the apparatus can have sensors and means to detect the steam region, electric voltage used by the heater, current, frequency, and time.

A control box for sending commands to the sampling unit, the adiabatic hot box, the cold box, and the mass measurement and removal unit, collecting information from sensors, identifying steam regions, controlling inductive heating and cooling means, and calculating steam quality. The control box may include a processor, a display unit, and an optional alert system. The apparatus can also have a remote transfer device that allows the operator to remotely control the apparatus or monitor the readings.

The apparatus has heat insulation to minimize heat loss to the environment and to make the apparatus cool to the touch, and, thus, operator friendly.

A method of using the apparatus to determine steam quality is also described herein. A saturated steam sample stream from a steam pipeline or wellhead is obtained by the sampling port. The initial temperature and pressure of said saturated steam sample is measured. A known amount of heat, ΔH, is added while simultaneously adjusting back pressure of the saturated steam sample stream to maintain a dynamic stabilized temperature and pressure gradient from the inlet and outlet of the heater. For example, the amount of heat is known based on the electrical current and voltage input into the heater.

Once the system is dynamically stabilized, the measurement period can begin. This measurement period can either run for a predetermined time or until a set mass of condensate is obtained. During the measurement period, the saturated steam sample is heated with said known amount of heat to form a superheated steam sample. The temperature and pressure of said superheated steam sample is measured and the enthalpy, h_{d}, of said superheated steam sample using a pressure-enthalpy diagram. The superheated steam sample is then condensed in the cold box wherein the resulting condensate is collected in the mass cup and measured. The steam quality, X_{B}, may be calculated using equation (4):

$${X}_{B} = \frac{{h}_{d} - Δ H / m - {h}_{f}}{{h}_{g} - {h}_{f}} ,$$

wherein h_{f} and h_{g} are enthalpy of formation and enthalpy of dry steam taken from a steam table for the pressures and temperatures of the steam as may be measured.

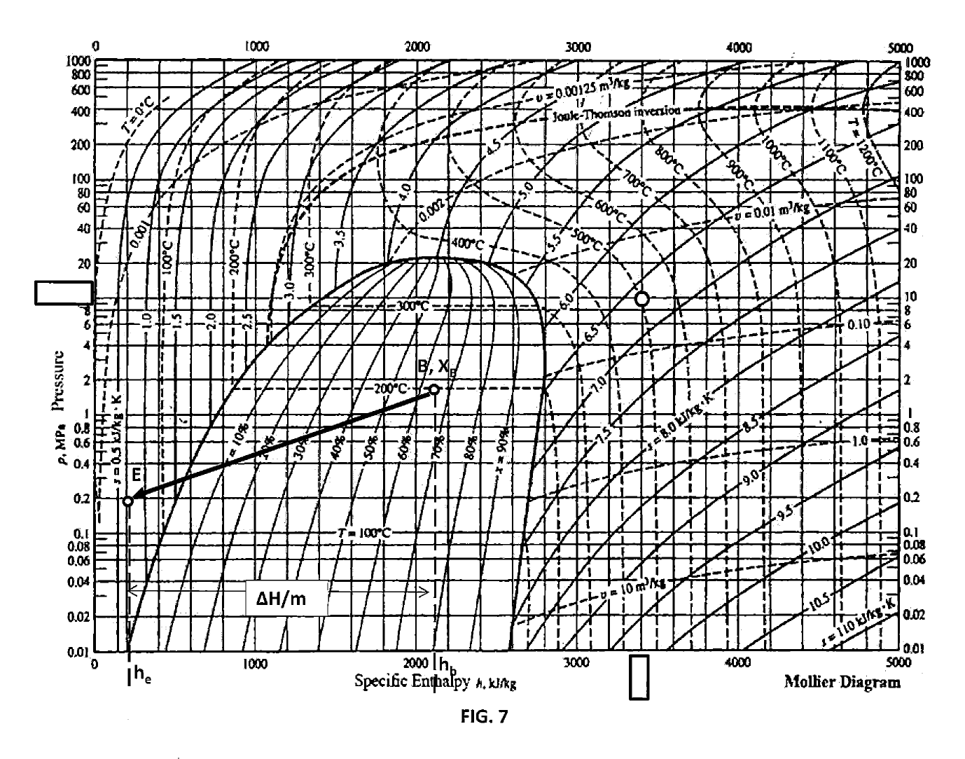

As illustrated in FIG. 7, heat can be removed from the steam sample stream and cool it into sub saturated water region to point E. E point can be determined by measured temperature and pressure provided the associated mass is known. Similar to the heating method, steam quality X_{B} is then calculated by equation (5)

$${X}_{B} = \frac{{h}_{e} + Δ H / m - {h}_{f}}{{h}_{g} - {h}_{f}}$$

The present apparatus is exemplified with respect to the description. However, this description is exemplary only, and the invention can be broadly applied to any industry that utilizes steam and desires a particular quality thereof. The following examples are intended to be illustrative only, and not unduly limit the scope of the appended claims.

### Calculations

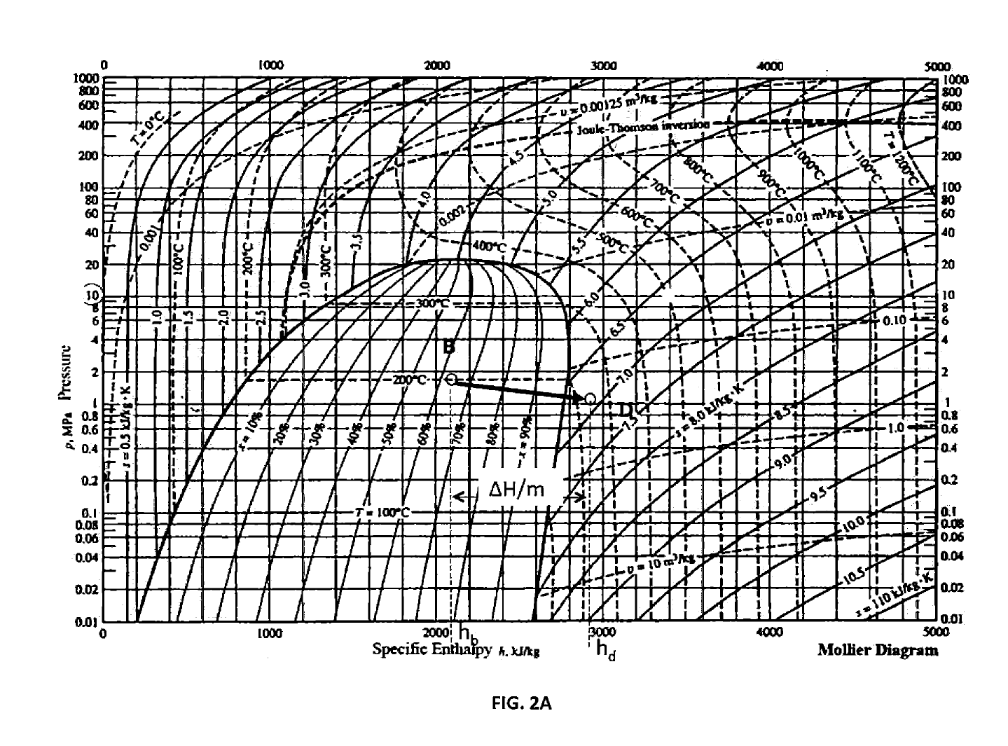

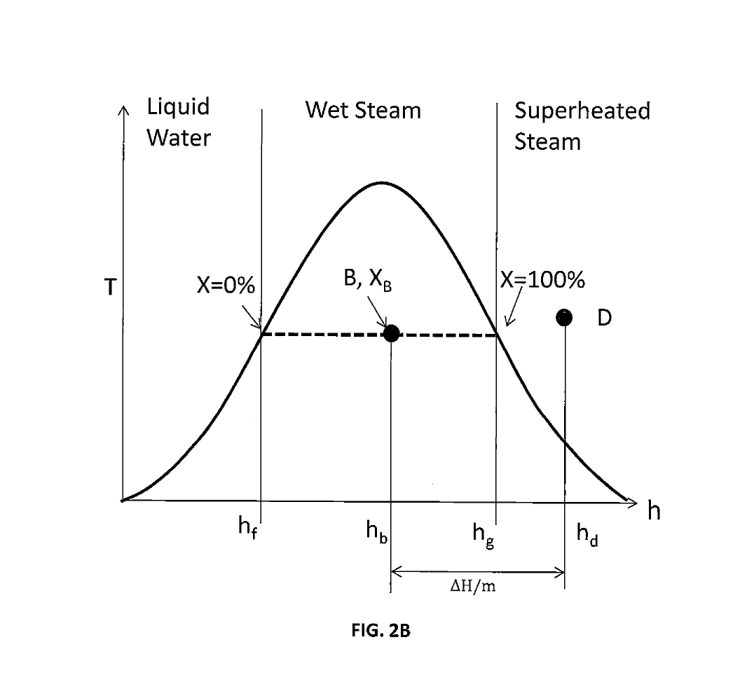

The underlying thermodynamics that form the basis for the design of the meter is described below and depicted in FIG. 2A. The present apparatus takes advantage of the fact that, in a flowing condition, a two-phase saturated steam mixture, having a starting point ‘B’, can absorb enough heat (ΔH), to pass through the two phase region into the superheated steam region. In this superheated region, the superheated enthalpy h_{d} can be determined by pressure and temperature at some point denoted D. Using the temperature and pressure measured at point B and point D and the amount of heat absorbed by the sample from point B to D, one can determine the steam quality of a known mass of steam using an enthalpy and pressure diagram shown in FIG. 2A. Alternatively, the calculations described below can determine the steam quality without the use of an enthalpy and pressure diagram.

In more detail, FIG. 2B shows point B, which represents the temperature, pressure and steam quality of a sample of saturated steam taken from a pipeline. While the temperature and pressure at point B can be measured, the steam quality is still unknown. In some prior art, the steam is supposed to be heated to the cusp of the saturated steam and superheated steam region. However, the steam ends up in the superheated region, as evidenced by noticeable change in temperature or pressure. The prior art's calculations do not account for this over heating. However, in the present disclosure, the steam is heated to point D, which is in the superheated steam region. Furthermore, the calculations herein do not assume a constant temperature and pressure as done in the prior art because it is not realistic of a steam sample that is flowing.

The steam quality meter herein utilizes calculations that account for superheating the steam and inconstant temperatures and pressures related to such. This approach leads to a more accurate determination of steam quality.

In the present meter, the saturated steam is purposely heated to the superheated region to a point D, wherein the temperature and pressure at point D can be measured. The amount of heat added to the steam, ΔH, and the enthalpy at point D is known by the meter. Using this information, the enthalpy h_{b} at point B can be determined using the enthalpy and pressure diagram in FIG. 2A or by equation 1:

h_{b}=h_{d}−ΔH/m Equation 1

Referring to FIG. 2B, X_{B} is then calculated through equation 2, 3, and 4, wherein equation 2 and 3 are an enthalpy balance equation and the steam quality definition.

$$\begin{matrix}{h}_{b} = {h}_{f} + {X}_{B} ( {h}_{g} - {h}_{f} ) {h}_{b} = {X}_{B} {h}_{g} + ( 1 - {X}_{B} ) {h}_{f} & Equation 2 \\ {X}_{B} = \frac{{h}_{b} - {h}_{f}}{{h}_{g} - {h}_{f}} & Equation 3\end{matrix}$$

Equation 4 is a combination of equation 1 into 3 and rearranged for X_{B}, wherein X_{B} is the steam quality being calculated by the presently disclosed steam quality meter, ΔH is the total heat used to convert the saturated steam at point B to superheated steam at point D, and m is the total mass absorbing ΔH.

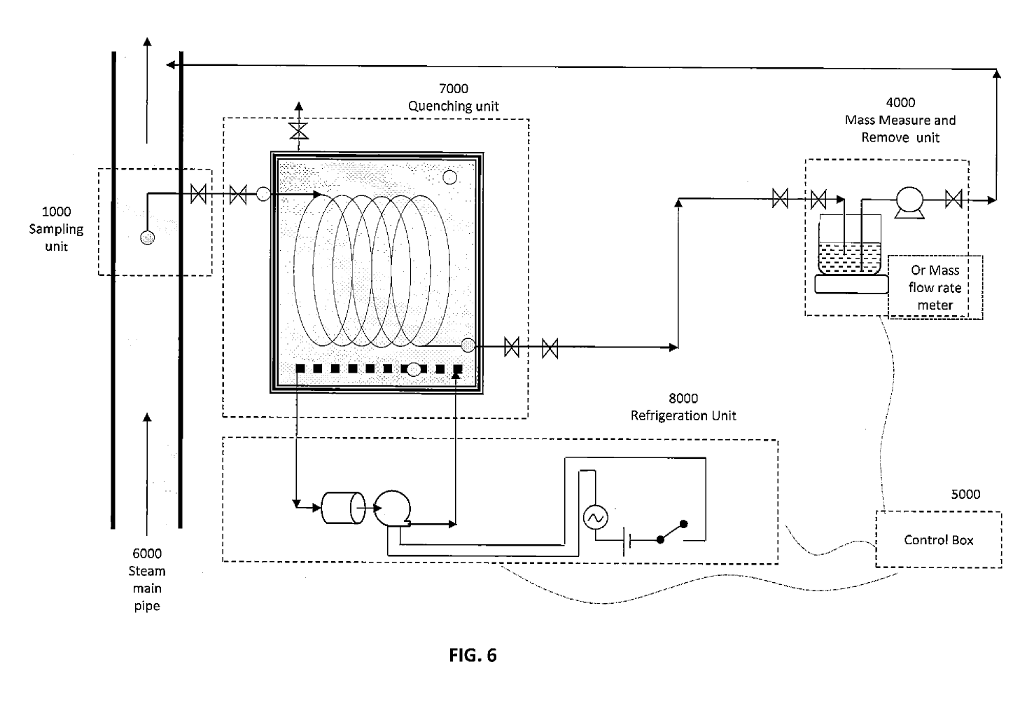

In a case a quenching method is adopted, where heat is removed from the system, steam stream is and convert it into sub-saturated water region. The process and calculation can be conducted as showing in FIG. 7. 8. and descripted as below: process end point E is determined by pressure and temperature measurement after quenching; removed enthalpy ΔH is measured via refrigeration unit 8000 and mass by 4000 as shown in FIG. 6. Other required parameters, h_{g}, h_{f}, are obtained from steam table. Steam quality X_{B} is then calculated by Equation below.

$${X}_{B} = \frac{{h}_{e} + Δ H / m - {h}_{f}}{{h}_{g} - {h}_{f}} \qquad Equation 5$$

FIG. 6 illustrates the schematic of the steam quality meter by quenching method.

Thus, for a given known mass of steam, only temperature and pressure at beginning point B and the final enthalpy h_{d}, or hₑ if quenching method is adopted, at point D, or point E if quenching method is adopted, is required to calculate h_{b}.

### Apparatus

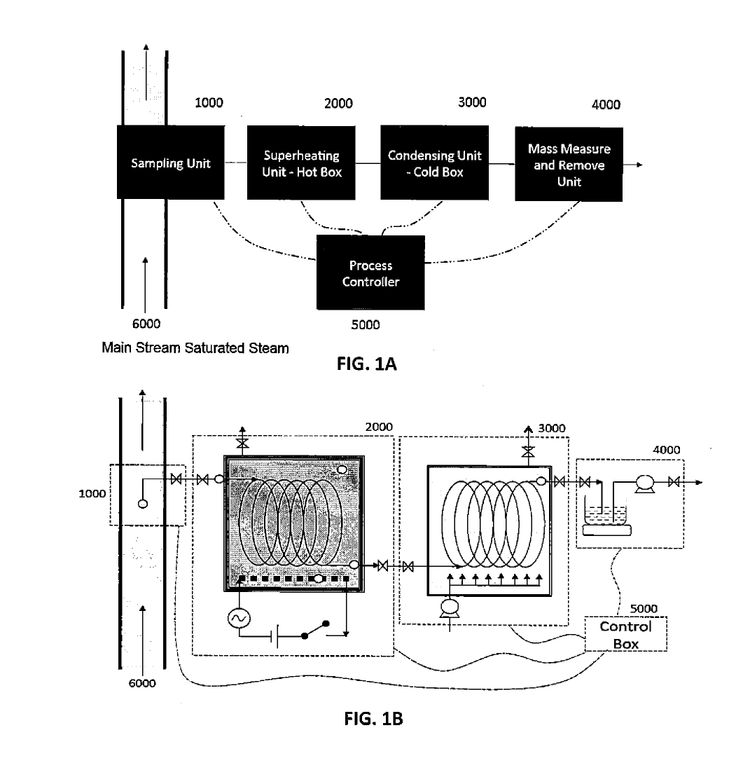

The presently disclosed apparatus depicted in FIGS. 1A-1B includes a sampling unit, an adiabatic hot box, a condensing unit, a mass measure and sample removal unit, and a process controller for controlling the various parts of the apparatus. While each part is described in more detail below, it should be understood that various changes, substitutions, and alterations can be made without departing from the spirit and scope of the invention as defined by the appended claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

Briefly, FIG. 1A displays simplified diagrams of the presently described unit which includes a sampling unit 1000 where saturated steam stream continuously flows from the main stream pipe 6000, an adiabatic superheating hot box 2000 where the stream absorbs the induction heat, a condensing unit, or a cold box, 3000 where the stream is cooled into condensate, a mass measurement and removal unit 4000 where total mass is measured, removed from the unit and finally is disposed or recycled. A process controller 5000 controls each part of the unit, including sensors for data collection and valves for process control. The process controller can also have a remote data transfer device to allow for remote communications. Such a device can send alerts to the operator when steam quality drops below a certain level or allow the operator to manage and control the meter off site.

Sampling Unit:

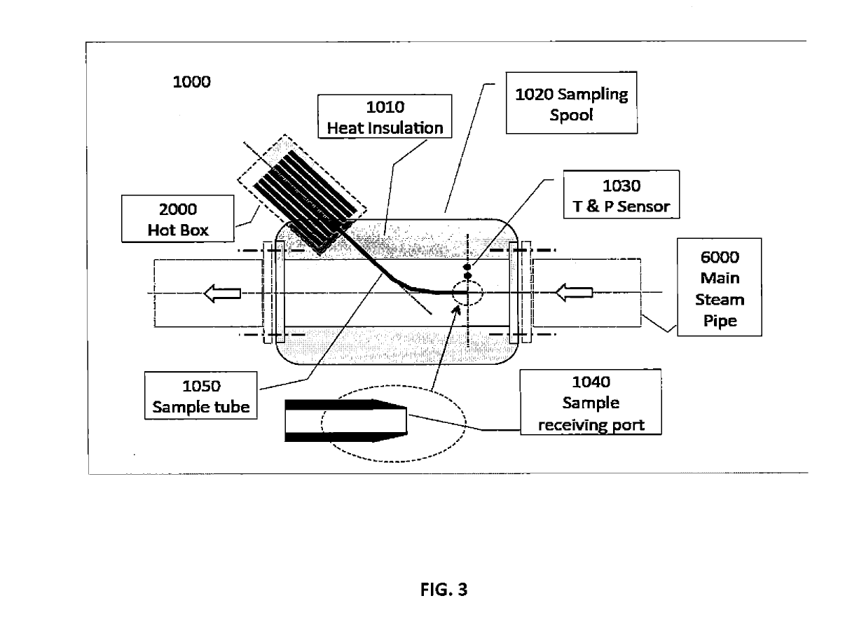

As shown in FIG. 3, a sampling spool 1020 is incorporated into a main steam stream pipe 6000. Heat insulation 1010 surrounds the sample spool 1020 to provide a stable sampling environment and to provide a low external surface temperature necessary for the unit to be operationally friendly. Examples of good heat insulators include using a vacuum insulated panel equipped with a gas getter, a radiation reflective coating with heat insulation material or any combination of these.

A sampling tube 1050 located in the center of the spool has a sharp end receiving port 1040. The sample tube 1050 is curved for less momentum related pressure losses. The receiving port 1040 has a flat entrance perpendicular to the flowing stream and in line with pressure and temperature sensors 1030 located close to the sample receiving port 1040. The pressure and temperature sensors, 1030, are of any type commercially available and designed for high temperature, pressure and water content.

Though FIG. 3 only shows one receiving port 1040, multi ports can be arranged in various configurations, each with their own set of sensors. Ideally, each port is connected to its own sampling tube 1050; however, it is also possible to have multiple receiving ports branching from a single sampling tube. The processor can be programmed to take samples for any one of the multiple receiving ports or can obtain multiple samples in series from the ports.

A stream of steam is transported by the sample tube 1050 and directed into the adiabatic hot box 2000 for superheating. Ideally, the sample tube 1050 directs the sample through the least interrupted path, thus using the minimal path length.

Adiabatic Hot Box:

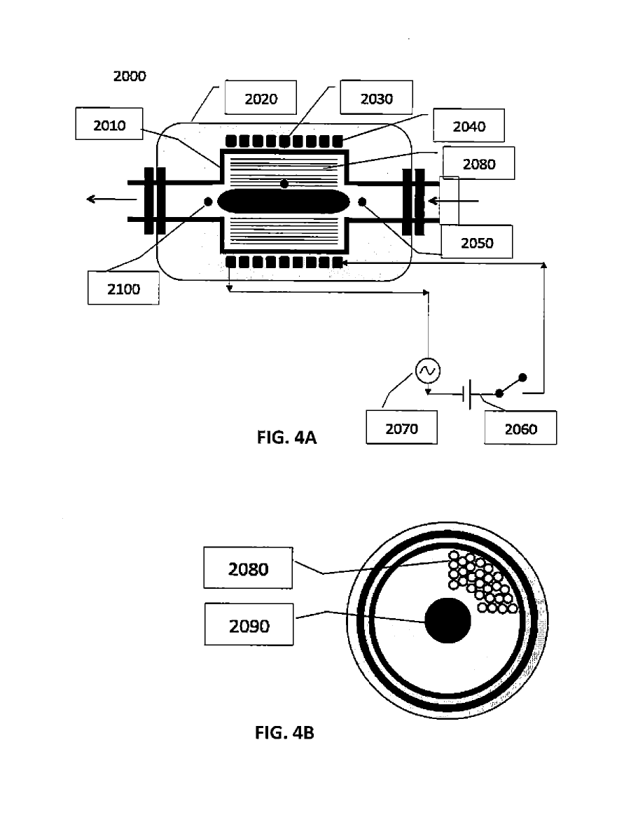

FIG. 4A displays a more detailed schematic of the adiabatic hot box used to superheat the steam sample stream. Steam samples are often fast flowing, with velocities close to sonic or ultra-sonic speeds, and having high temperatures and pressures. To accommodate these characteristics, the presently disclosed apparatus uses an induction heater 2040 for quickly and efficiently super heating the sample within multiple conduit or grid paths in an induction created magnetic field.

As schematically shown in FIG. 4A, the hot box 2000, has an adiabatic container 2020 to limit heat loss and, therefore, ensure that the inductive heat is being absorbed by the passing steam with ignorable heat loss to the ambient. Like the sampling spool 1020, heat insulation can be realized through the use of vacuum insulated panels with gas getters or heat insulation material or a combination thereof. The surfaces of the adiabatic container 2020 are preferably chrome to reduce radiation heat transfer. However, a color coating or other method can be used.

The hot box 2000 has the induction heater 2040, with electric coil made of any conductive material typically used for induction heating with multiple metal heat transfer tubes 2080. The electrical coils are placed external to and wrap around a heater shell 2010. For the metal tubes and structures, materials prone to hysteresis should be avoided. A temperature sensor 2030 monitors the electrical coil temperature for safety.

The induction heater converts energy from an electrical source to heat via a magnetic field. The electrical circuit is also displayed in FIG. 1B, in the hot box 2000. In the center of the electric coils is a heater shell 2010 that houses multiple concentric configured layers of metal heat transfer tubes 2080, as shown in FIG. 4B. Suitable materials for the heater shell 2010 include ceramics, which allow for penetration of the electric/magnetic fields produced by the coils, but are also have mechanical strength and high temperature resistance, as preferred.

Even though FIG. 4B shows only a few metal tubes 2080 inside the heater shell 2010, the entire middle section is filled with these tubes. The metal tubes are composed of any conducting material such as carbon steel, copper, silver, gold, aluminum, lead, magnesium, platinum, or tungsten. Each of the tubes quickly absorbs the magnetic field energy and converts it into heat that can be transferred to steam.

These multiple metal heat transfer tubes are open on both ends and spaces between the tubes are also open. As such, both inner and outer surfaces contribute to the total contacting surface to facilitate heat transfer to the incoming sample. While shown as having a circular cross-section, the tubes can have any cross section shape and are not necessarily tubular. They can be, for instance, a matrix of flat plate grids. Furthermore, in order to obtain desired radiation transfer, the inner and outer surfaces of the tubes may be treated with a black color. The length of the tubes is designed to satisfy the steam resident time need.

The resident time is the time it takes the steam sample to travel from the inlet 2050 to the outlet 2100 of the hot box 2000 shown in FIG. 4A. It is also illustrated by point B to D of FIG. 2A. Adequate resident time is necessary to ensure that the steam sample is heated to the desired superheated degree. Resident time is controlled by the amount of heat added and the rate of heat transfer plus the mass and velocity of the sample stream. The large heated contacting surface area of the tubes 2080, achieved by using the multi-tube or grid design, and the ability to allow steam distribution into these tubes allows for shorter path distances to be used. Using the currently available knowledge of heat transfer and induction heating, proper sizing and dimensioning of the hot box and its furnace components can be achieved for any steam sources. Thus, the hot box can be customized for faster moving or larger sampling without sacrificing residence time.

A velocity distributor or space filler 2090 may be located in the center of the heater to divert steam in order to allow uniform velocity distribution to the tubes 2080. As FIG. 4A illustrates, electrical energy is delivered into the system supported by an electric power source 2060 and measured by a watt meter 2070. Device 2070 is capable of measuring the voltage, current and frequency applied to the hot box 2000. Temperature and pressure sensors 2050 take measurements of the sample as it enters the hot box before being heated. The acquired values represent point B of FIG. 2A. A second set of sensors 2100 are located before the sample leaves the hot box, after being heated. The acquired values represent point D of FIG. 2A.

The energy inducted into the system is controlled by controller 5000 (see FIGS. 1A-1B). The controller 5000 establishes and maintains the desired superheating temperature and pressure of the sample under a dynamically stabilized flowing condition. To dynamically stabilize the flowing conditions, the controller adjusts the steam stream flow rate and the amount of energy being inputted into the hot box such that the temperature and pressure gradients at the entrance and exit of the hot box are stable. Once the hot box is dynamically stabilized, then a measurement period can begin.

After being superheated, the steam is then transferred from the hot box to the cold box to be condensed and weighed.

Condensing Cold Box:

The cold box 3000 shown in FIG. 1B is located downstream to the hot box. The superheated steam sample from the hot box 2000 is introduced in the cold box 3000 for cooling to a temperature lower than the atmospheric boiling point. Ideally, this is a temperature range of 20-40° C., which is preferred for safety and is operationally convenient. The sample is quenched using preferably air-cooling methods; however, other methods can be used to quench the steam, such as a chiller, cooled air, or water-cooling. The cooling mechanism can include coils or pipes in the cold box, or other types of heat exchangers or it can flow in a unidirectional manner so long as the steam is completely condensed. The cold box is designed such that cooling capacity can be adjusted, via controller 5000, depending on steam sampling flow rate.

A sensor can be located at the outlet of the cold box. Ideally, at least one temperature sensor is utilized; however, other sensors and multiples thereof can be used. Once the sample is condensed, it can be measured and removed from the meter.

Mass Measurement:

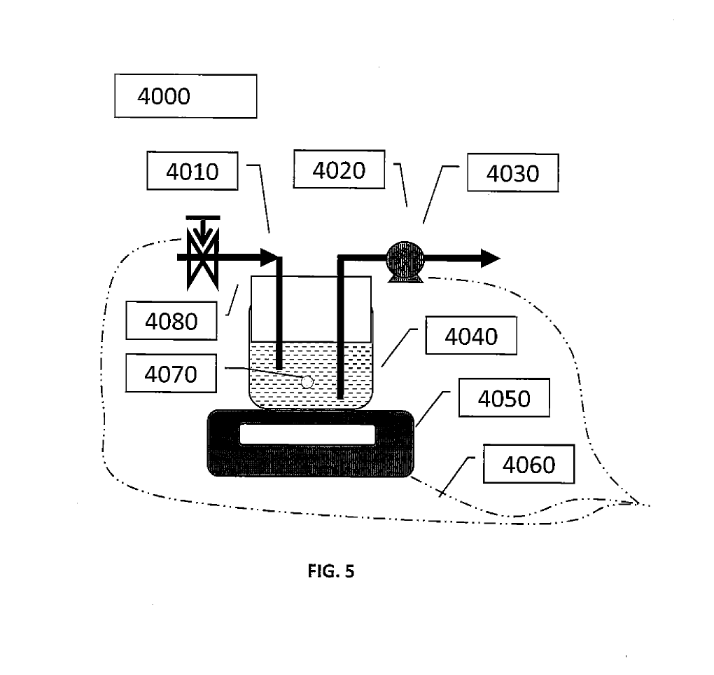

With respect to the total mass measurement and removing system 4000 shown in FIG. 5, the condensate has in-flow line 4010 and out-flow line 4020. The in-flow line 4010 has a backpressure control valve 4080 that controls steam flowing rate of the total system as well as the pressure gradient. As an alternative, the controllable backpressure valve 4080 can be located at the cold end of the cold box 3000. The condensate is collected in a mass cup 4040 wherein the top of the cup is open to the atmosphere. The total mass for each measurement period is measured by electric balance 4050.

Between each measurement period, a pump 4030 removes the collected condensate. The removed condensate can be recycled, reused or injected back to main stream line or be discarded.

The measurement period can be customized for a specific application. What this means is that the measurement period may be longer for faster flowing samples that require longer resident times in the hot box. Alternatively, the measurement periods can be timed to coincide with other processes occurring along with the steam generation. For example, the steam quality measurements can be used as a real time monitor for changes being made to the steam generator during a maintenance period.

Compared to other methods of measurement, such as flow rate meter, the total mass measurement unit described here provides direct and accurate calculations due to fewer variables involved, such as density, which is a function of temperature.

In some embodiments, the steam stream flow is continuous but the measurement is periodic. The measurement circle is repeated to form semi-continuous measurements.

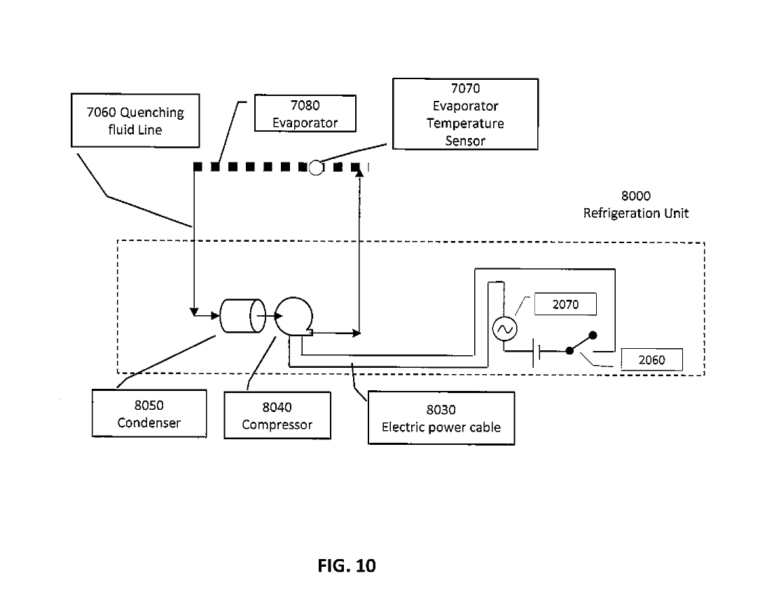

FIG. 6 shows an alternative or optional embodiment of the present invention. Instead of adding heat, the steam quality meter uses a quenching unit 7000 that takes heat away from the steam stream sample that is continuously flowing from the steam main pipe 6000 to the sampling unit 1000 and to a desired sub-saturated water region. A heat removing unit 8000 (e.g., a refrigeration unit) removes heat and the related consumed energy is recorded and calibrated by electric power unit 2070 and 2060 (see FIG. 10). Similar to the embodiment shown in FIGS. 1A-1B, the unit shown in FIG. 6 also features a mass measure and remove unit 4000 and control box 5000. The mass measurement and removal unit 4000 is where total mass is measured, removed from the unit and finally disposed or recycled. A process controller or control box 5000 controls each part of the unit, including sensors for data collection and valves for process control.

FIG. 7 shows the underlying thermodynamics that form the basis for the design of the meter shown in FIG. 6 This diagram shows point B which has a unknown steam quality X_{B}. Thermodynamically, the quenching process moves from point B to point E by removing heat ΔH/m where ΔH (total inputted energy or heat removed from B to E) is measured by refrigeration unit 8000 and m (measured mass associated with ΔH) is measured by mass measure and remove unit 4000. Pressure and temperature change along with the process. The specific enthalpy at E (hₑ) at sub-saturated water can be determined once its pressure and temperature is measured at point E. Only final state at E is required to calculate h_{b} and X_{B} since h_{b}=hₑ+ΔH/m. X_{B} can be solved graphically or by enthalpy ratio formula.

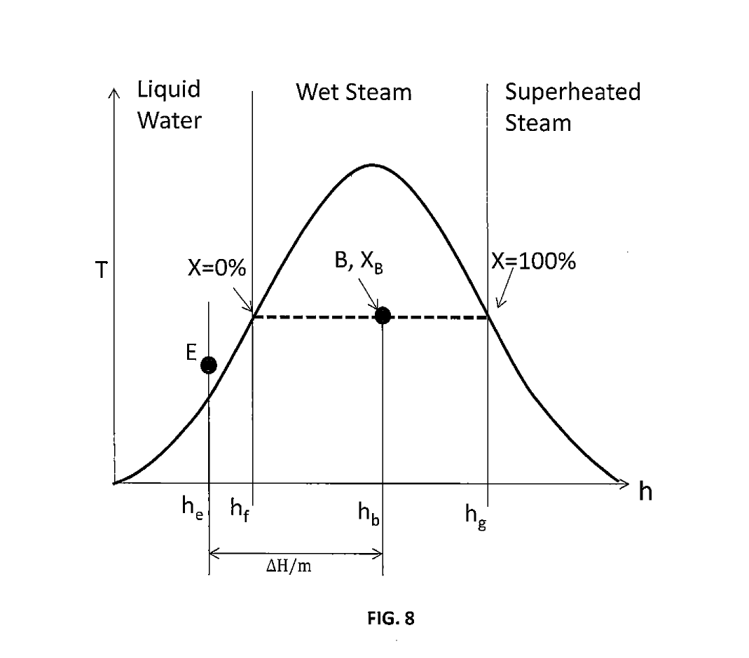

FIG. 8 shows point B of FIG. 7, which represents the temperature, pressure and steam quality of a sample of saturated steam taken from a pipeline. For quenching method, equation (4) becomes

$${X}_{B} = \frac{{h}_{e} + Δ H / m - {h}_{f}}{{h}_{g} - {h}_{f}} \qquad ( 5 )$$

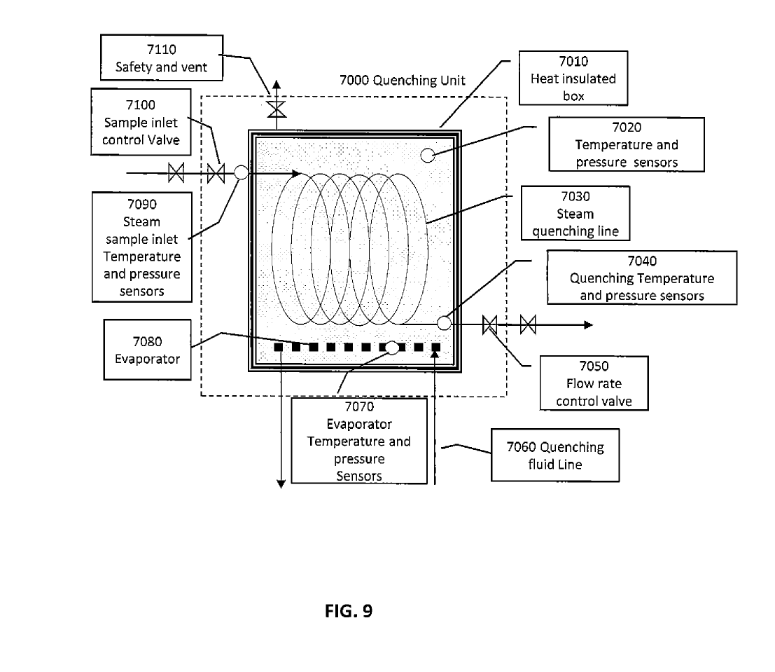

FIG. 9 shows a close-up schematic of the quenching unit 7000. The various parts of the quenching unit are contained within the diabetic box defined by 7010. As shown, steam continuously flows through steam quenching line 7030. This steam quenching line may be any known heat exchanger that is compatible with the present invention. Temperature/pressure sensors 7020, 7040, 7070, and 7090 have been placed at various locations corresponding to the diabetic unit, exit of quenching unit, cold source, and inlet, respectively. Sensor 7090, in particular, is located outside of the diabetic unit and the line from the sampling unit 1000 to the quenching unit 7000 is heat insulated. Flow rate of the sample stream is controlled by flow rate control valve 7050 and/or sample inlet control valve 7100. 7080 is cold sinks (evaporators) that removes heat from the sample stream that flows into through the steam quenching line 7030.

FIG. 10 shows a close-up view of the refrigeration unit 8000. The refrigeration unit can provide cold sink to the system. As a typical refrigeration unit, it includes a condenser 8050 and compressor 8040 along with the quenching fluid line 7060. Electric energy used to drive the refrigeration can be used to calculate the consumed quenching energy. The energy in electric form and in heat form can be calibrated to provide better accuracy of calculation. Other cold sinks, for example, thermoelectric cooling device can also be used.

1. An apparatus for measuring steam quality, comprising:
a sampling unit for obtaining a stream of saturated steam;
a hot box fluidly connected to the sampling unit and having an inductive heater with one or more electrical coils surrounding one or more open end metal structures heated by induction and in contact with the saturated steam to produce superheated steam;
at least one sensor to measure temperature and pressure of the superheated steam;
a condensing cold box fluidly connected to the hot box in order to condense the superheated steam into a condensate;
a mass measurement and sample removal unit fluidly connected to receive samples output from the cold box; and
a processing unit for calculating steam quality based on enthalpy of the superheated steam determined by measurement of the temperature and pressure, mass of the samples output from the cold box and energy input via the inductive heater.

2. The apparatus of claim 1, further comprising a remote data transfer device.

3. The apparatus of claim 1, wherein the sampling unit further senses temperature and pressure of the saturated steam.

4. The apparatus of claim 1, wherein the sampling unit and hot box include insulation chosen from vacuum insulated panels, radiation reflecting coating or any combination thereof.

5. The apparatus of claim 1, wherein electrical coils are disposed external of a shell that houses the metal structures of the hot box.

6. The apparatus of claim 1, wherein the metal structures are composed of magnetic conducting and heat conductive metals that include carbon steel, copper, silver, gold, aluminum, lead, magnesium, platinum, tungsten or any combination thereof.

7. The apparatus of claim 6, wherein the metal structures have an elongated hollow shape.

8. The apparatus of claim 6, wherein the metal structures are flat plate grids.

9. The apparatus of claim 1, further comprising a nonmagnetic velocity distributor disposed in the hot box to divert flow of the saturated steam toward the metal structures.

10. The apparatus of claim 9, wherein the metal structures are disposed concentrically around the velocity distributor.

11. The apparatus of claim 1, wherein the hot box includes a shell that houses the metal structures and is composed of ceramic.

12. The apparatus of claim 1, wherein the hot box further includes a meter to sense electric voltage and current input to the electrical coils.

13. The apparatus of claim 1, wherein the mass measurement and sample removal unit includes an electric mass balance or a load cell.

14. The apparatus of claim 1, wherein the mass measurement and sample removal unit further includes a pump for periodic removal of the samples.

15. The apparatus of claim 1, wherein the mass measurement and sample removal unit further includes a pump for removal of the samples at a predetermined time or accumulated mass.

16. The apparatus of claim 1, wherein the condensate is recycled for generating additional steam.

17. A method of determining steam quality, comprising:
obtaining a stream of saturated steam at an initial temperature and pressure;
adding a known amount of heat, ΔH, to the saturated steam thereby forming superheated steam while back pressure is adjusted to maintain a dynamic stabilized temperature and pressure gradient or removing heat from the saturated stream to make the sample stream sub-saturated water;
determining enthalpy, h_{d}, of the superheated steam based on a measured temperature and pressure of the superheated steam;
condensing the superheated steam to form a condensate sample;
measuring mass, m, of the condensate sample; and
computing steam quality, X_{B}, using equation:
$${X}_{B} = \frac{{h}_{d} + Δ H / m - {h}_{f}}{{h}_{g} - {h}_{f}} ,$$
wherein h_{f} and h_{g} are enthalpies of formation and dry steam that are taken from a steam table given the temperatures and pressures or computing steam quality X_{B} using equation:
X_{B}=(hₑ+ΔH/m−h_{f})/(h_{g}−h_{f}).

18. A method of determining steam quality, comprising:
introducing a flow of saturated steam at an inlet temperature and pressure into an inductive heater to produce a superheated steam;
measuring outlet temperature and pressure of the superheated steam exiting from the heater to determine enthalpy of the superheated steam,
condensing the superheated steam to provide a sample having a mass for a measurement period;
determining amount of heat delivered to the saturated steam by the inductive heater during the measurement period; and
computing steam quality based on the enthalpy of the superheated steam, the mass of the sample and energy input via the inductive heater.

19. The method of claim 18, wherein the measurement period is a predetermined time interval.

20. The method of claim 18, wherein the measurement period is based on a predetermined collected amount for the mass.

21. An apparatus for measuring steam quality, comprising:
a sampling unit for obtaining a stream of subsaturated water;
a quenching unit fluidly connected to the sampling unit and having a cold sink for cooling a steam stream sample to produce subsaturated water stream;
at least one sensor to measure temperature and pressure of the subsaturated water stream;
a mass measurement and sample removal unit fluidly connected to receive samples output from the cold box; and
a processing unit for calculating steam quality based on enthalpy of the subsaturated water stream determined by measurement of the temperature and pressure, mass of the samples output from the cold box and energy input via the cold sink.

22. The apparatus of claim 21, wherein the cold sink is a refrigeration unit.

23. The apparatus of claim 21, wherein the apparatus includes temperature and pressure sensor that measure steam stream sample prior to the steam stream sample flowing into the quenching unit.

24. The apparatus of claim 21, wherein the apparatus includes temperature and pressure sensor that measure steam stream sample inside the quenching unit.

25. The apparatus of claim 21, wherein flow rate of the steam stream sample is controlled by valves at inlet, outlet, or both.

26. The apparatus of claim 21, wherein measurement period is repeated to make a semi continued measurement.
